(19) United States
(12) Patent Application Publication
(10) Pub. No.: US 2013/0021261 A1
(43) Pub. Date: Jan. 24, 2013

(54) ELECTRONIC DEVICE AND METHOD OF CONTROLLING SAME

(71) Applicants: Kelce WILSON, Irving, TX (US); Young Ae KIM, Rolling Meadows, IL (US); Susan LUKASIK, Lombard, IL (US)

(72) Inventors: Kelce WILSON, Irving, TX (US); Young Ae KIM, Rolling Meadows, IL (US); Susan LUKASIK, Lombard, IL (US)

(73) Assignee: RESEARCH IN MOTION LIMITED, Waterloo (CA)

(21) Appl. No.: 13/185,171

(22) Filed: Jul. 18, 2011

(51) Int. Cl. G09G 5/00; G06F 3/041

(52) U.S. Cl. 345/173; 345/1.3

(57) ABSTRACT

A method includes establishing communication between a first portable electronic device and a second portable electronic device, wherein the first portable electronic device includes a first processor and by the first processor, displaying first information on a first display of the first electronic device and controlling the second portable electronic device to display second information on a second display of the second portable electronic device.

### FIELD OF TECHNOLOGY

The present disclosure relates to electronic devices including, but not limited to, electronic devices having displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones (smart phones), Personal Digital Assistants (PDAs), tablet computers, and laptop computers, with wireless network communications or near-field communications connectivity such as Bluetooth® capabilities.

Portable electronic devices such as PDAs, or tablet computers are generally intended for handheld use and ease of portability. Smaller devices are generally desirable for portability. A touch-sensitive display, also known as a touchscreen display, is particularly useful on handheld devices, which are small and may have limited space for user input and output. The information displayed on the display may be modified depending on the functions and operations being performed. Improvements in electronic devices with displays are desirable.

### BRIEF DESCRIPTION OF THE DRAWINGS

FIG. 1 is a block diagram of a portable electronic device in accordance with an example embodiment.

FIG. 2 is a front view of an example of a portable electronic device in accordance with the disclosure.

FIG. 3 is a front view of an interface utilized to couple portable electronic devices in accordance with the disclosure.

FIG. 4 is a flowchart illustrating a method of controlling display of information in accordance with the disclosure.

FIG. 5 is a flowchart illustrating a method of display control in accordance with the disclosure.

FIG. 6 is a flowchart illustrating a method of synchronization of documents in accordance with the disclosure.

FIG. 7 is a flowchart illustrating a method of coordinating the display of information in accordance with the disclosure.

FIG. 8 through FIG. 10 are views of another interface utilized to couple portable electronic devices in accordance with the disclosure.

### DETAILED DESCRIPTION

The following describes an electronic device and a method that includes establishing communication between a first portable electronic device and a second portable electronic device, wherein the first portable electronic device includes a first processor, and by the first processor, displaying first information on a first display of the first electronic device and controlling the second portable electronic device to display second information on a second display of the second portable electronic device.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, which is a portable electronic device in the embodiments described herein. Examples of portable electronic devices include mobile, or handheld, wireless communication devices such as pagers, cellular phones, cellular smart-phones, wireless organizers, PDAs, wirelessly enabled notebook computers, tablet computers, and so forth. The portable electronic device may also be a portable electronic device without wireless communication capabilities, such as a handheld electronic game device, digital photograph album, digital camera, or other device.

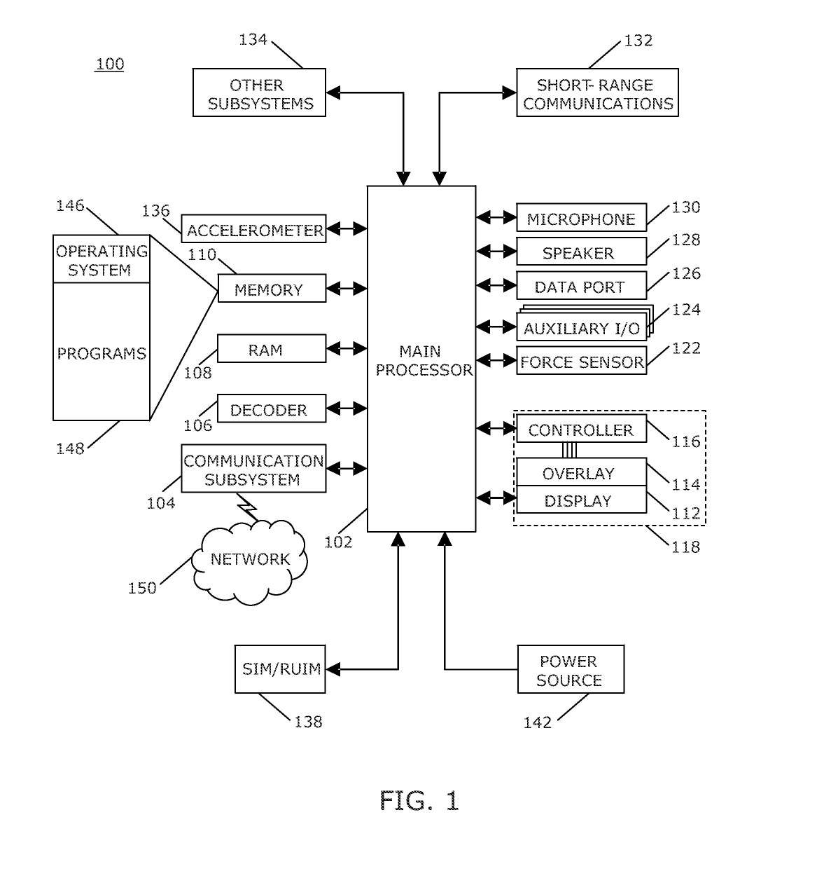

A block diagram of an example of a portable electronic device 100 is shown in FIG. 1. The portable electronic device 100 includes multiple components, such as a processor 102 that controls the overall operation of the portable electronic device 100. The processor 102 may be a single processor, a dual-core processor, or multiple processors, although the processor 102 is referred to in singular form. The portable electronic device 100 presently described optionally includes a communication subsystem 104 and a short-range communications 132 module to perform various communication functions, including data and voice communications. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with a touch-sensitive overlay 114 operably connected to an electronic controller 116 that together comprise a touch-sensitive display 118, one or more force sensors 122, an auxiliary input/output (I/O) subsystem 124, a data port 126, a speaker 128, a microphone 130, short-range communications 132, and other device subsystems 134. User-interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an orientation sensor such as an accelerometer 136 to detect direction of gravitational forces or gravity-induced reaction forces, for example, to determine the orientation of the electronic device 100.

To identify a subscriber for network access, the electronic device 100 may optionally use a Subscriber Identity Module or a Removable User Identity Module (SIM/RUIM) card 138 for communication with a network, such as the wireless network 150. Alternatively, user identification information may be programmed into memory 110.

The electronic device 100 includes an operating system 146 and software programs or components 148 that are executed by the processor 102 and are typically stored in a persistent, updatable store such as the memory 110. Additional applications or programs may be loaded onto the electronic device 100 through the wireless network 150, the auxiliary I/O subsystem 124, the data port 126, the short-range communications subsystem 132, or any other suitable subsystem 134.

A received signal, such as a text message, an e-mail message, or web page download, is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104, for example.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display includes a capacitive touch-sensitive overlay 114. The overlay 114 may be an assembly of multiple layers in a stack which may include, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

The display 112 of the touch-sensitive display 118 may include a display area in which information may be displayed, and a non-display area extending around the periphery of the display area. Information is not displayed in the non-display area, which is utilized to accommodate, for example, electronic traces or electrical connections, adhesives or other sealants, and/or protective coatings around the edges of the display area.

One or more touches, also known as touch contacts or touch events, may be detected by the touch-sensitive display 118. The processor 102 may determine attributes of the touch, including a location of a touch. Touch location data may include an area of contact or a single point of contact, such as a point at or near a center of the area of contact. A signal is provided to the controller 116 in response to detection of a touch. A touch may be detected from any suitable input member, such as a finger, thumb, appendage, or other objects, for example, a stylus, pen, or other pointer, depending on the nature of the touch-sensitive display 118. The controller 116 and/or the processor 102 may detect a touch by any suitable input member on the touch-sensitive display 118. Multiple simultaneous touches may be detected.

One or more gestures may also be detected by the touch-sensitive display 118. A gesture, such as a swipe, also known as a flick, is a particular type of touch on a touch-sensitive display 118 and may begin at an origin point and continue to an end point. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

An optional force sensor 122 or force sensors may be disposed in any suitable location, for example, between the touch-sensitive display 118 and a back of the electronic device 100 to detect a force imparted by a touch on the touch-sensitive display 118. The force sensor 122 may be a force-sensitive resistor, strain gauge, piezoelectric or piezoresistive device, pressure sensor, or other suitable device. Force as utilized throughout the specification refers to force measurements, estimates, and/or calculations, such as pressure, deformation, stress, strain, force density, force-area relationships, thrust, torque, and other effects that include force or related quantities.

Force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

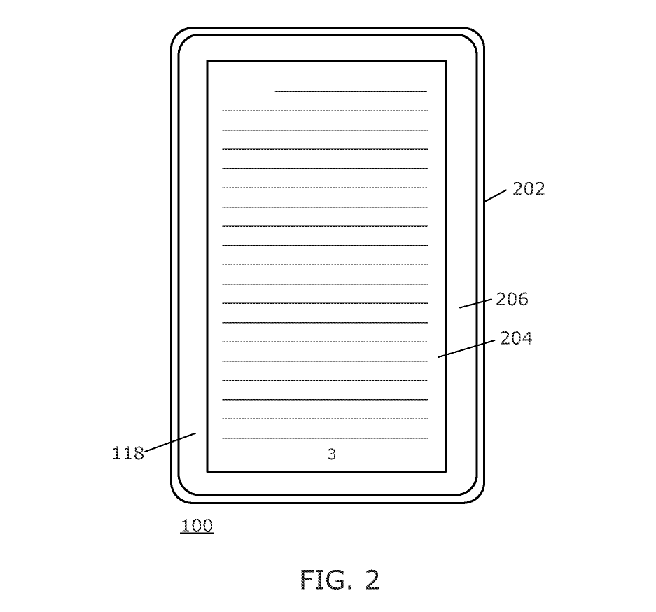

A front view of an example of the electronic device 100 is shown in FIG. 2. The electronic device 100 includes a housing 202 in which the touch-sensitive display 118 is disposed. The housing 202 and the touch-sensitive display 118 enclose components such as the components shown in FIG. 1. The display area 204 of the touch-sensitive display 118 may be generally centered in the housing 202. The non-display area 206 extends around the display area 204.

The touch-sensitive overlay 114 may extend to cover the display area 204 and the non-display area 206 such that a touch on either or both the display area 204 and the non-display area 206 may be detected. The density of touch sensors may differ between the display area 204 and the non-display area 206. For example, the density of nodes in a mutual capacitive touch-sensitive display, or density of locations at which electrodes of one layer cross over electrodes of another layer, may differ between the display area 204 and the non-display area 206. No image is displayed or displayable in the non-display area 206.

Portable electronic devices, such as the portable electronic device 100, provide many features and capabilities. One useful function is the ability to display one or more documents that include a large amount of information. For example, compilations of books, volumes of an encyclopedia, manuals, and so forth may all be stored on a portable electronic device. For example, a tablet computer with 64 gigabytes of memory and weighs about one or two pounds may easily replace 40 or 50 pounds of books. Such a reduction in weight and volume provides many advantages. For example, a person who is travelling is able to download, for example, 20 to 30 books, instead of having to choose one or two, without increasing the amount of luggage needed to travel. An airline pilot or co-pilot is able store the aircraft's manuals on a tablet computer, saving valuable space and weight in a cockpit, while adding the capability of electronically searching through the manuals for quick access, as another example. Students who download all of their schoolbooks, for example, do not have to carry a number of large, heavy books back and forth to school. In another example, attorneys may store case files and doctors may store patient files for easy carrying and retrieval without removing physical files from their offices.

Although the advantages of storing significant amounts of information on a portable electronic device are many, physical books have advantages. For example, when a book is open, up to twice the amount of information may be viewed at a given time. People are very comfortable reading books and their logistics. Described herein is a method and apparatus for displaying information on two portable electronic devices operating in tandem. The method may be extended to more than two devices. A single document is displayed on the displays of two portable electronic devices thereby providing more area to display the document. One of the portable electronic devices may control the display of the document such that the two devices act as if they are a single device unitarily displaying one document across both displays. For example, two tablets in a side-by-side arrangement may display one page on the left tablet, while the next consecutive page is displayed on the right tablet. When the page is turned, the tablets coordinate the display of pages as if the page was turned on a physical book. For example, if page 10 is displayed on the left tablet and page 11 is displayed on the right tablet, changing the page forward may result in displaying page 12 on the left tablet and page 13 is displayed on the right tablet. The coordination of display of the document, including such page turning, is provided between the processors of the tablets. The document may be stored on one or both devices. Control of the display on both tablets may be provided by either tablet, for example, in a process that identifies or establishes which device controls the coordination of the display.

Additional features beyond simple page display may be provided. For example, non-consecutive pages may be displayed, such as a table of contents or index on one device while a part of the text of the book is displayed on the other device. When a search results in many items being displayed, the items may be displayed across both displays, or one display may show the search results while the other display shows a preview of the search results as each search result is touched, highlighted, or otherwise selected. Pages or parts of pages may be displayed in any order. Document control may be provided between the two portable electronic devices such that each of the devices has the same document, e.g., the most current version of a document. The document may be stored on one or both devices for display. Processors from one or both of the portable electronic devices may control the selection and display of information. The devices may be utilized in both in portrait orientation, both in landscape orientation, or one device in each orientation.

Additional security features may be provided to prevent unauthorized use of the data between the devices. A secure communication path between the devices may be provided, for example, by authenticating the devices with each other and optionally providing encryption. A physical communication path may be utilized to avoid wireless interception of information. A physical interface may be provided to secure the devices physically to avoid breaking any established communication link between the devices. The interface may lock the devices physically and may include processing capability, for example, to identify when one or more portable electronic devices are coupled, to authenticate the devices, to provide electronic security between the devices, to act as a go-between to make inter-device decisions, to provide any other logical process to enhance the tandem use of the devices, and so forth.

The portable electronic device 100 may be coupled to other devices such as another portable electronic device by wireline connection utilizing the data port 126. The data port may be, for example, a Universal Serial Bus (USB) connector, mini USB, micro USB, or any other suitable connector. The connection facilitates transfer of data between devices. Alternatively, the portable electronic device may be wirelessly coupled to other devices utilizing the short-range communications, which may include, for example, Bluetooth®, or infrared communications.

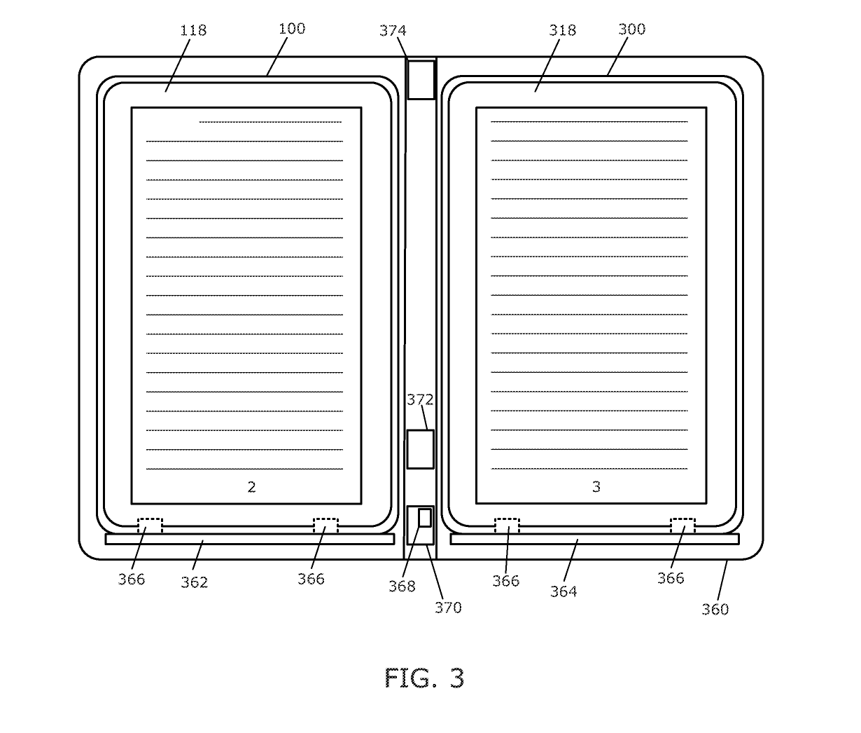

An example of an interface utilized to couple the portable electronic device 100 to an additional portable electronic device 300 is illustrated in FIG. 3. The additional portable electronic device 300 may be similar to the portable electronic device 100 and may execute software to facilitate cooperation between the portable electronic device 100 and the additional portable electronic device 300. Both portable electronic devices 100, 300 may be identical, or they may differ in any manner, including software, hardware, or software and hardware.

The interface 360 includes a member 362 for supporting and coupling to the portable electronic device 100 and a member 364 for coupling to the additional portable electronic device 300. The members 362, 364 may include, for example, USB connectors 366 that couple the interface 360 to each of the portable electronic devices 100, 300 and couple the portable electronic devices 100, 300 together.

The interface 360 may include a processor to identify when the portable electronic device 100 is coupled to the interface 360 and when the portable electronic device 300 is coupled to the interface 360. The interface 360 may also authenticate both portable electronic devices 100, 300. For example, the interface 360 may include a Physical Unclonable Function (PUF) 368 to register the interface 360 to the portable electronic device 100 and confirm that the interface 360 is an approved and authentic device. The PUF 368 may also be utilized to register the interface 360 to the additional portable electronic device 300.

To register the interface 360, the portable electronic device 100 may include a list of PUF unique identifiers stored in memory 110 that are utilized to identify each interface 360 that is authorized for coupling to the portable electronic device 100. The portable electronic device 100 generates a random message and sends the message to a controller 370 that includes the PUF 368. The controller 370 queries the unique identifier of the PUF 368, appends the unique identifier to the message received from the portable electronic device 100, and hashes the message with the appended unique identifier. The controller 370 sends the hash value back to portable electronic device 100. The portable electronic device 100 utilizes the list of PUF unique identifiers, for example, starting at the top of the list, and appends the first unique identifier in the list to the random message. The random message along with the unique identifier is hashed by the processor 102 of the portable electronic device 100 and the hash value is compared to the hash value received from the controller 370. When the two hash values match, the interface 360 is an authorized interface. When the two hash values do not match, subsequent identifiers in the list are utilized by appending to the random message, hashing, and comparing to the hash value received from the interface 360 until the hash values match. If no match is found, then there is no authentication. The controller 370 may be the processor for the interface 360.

When the portable electronic device 100 is coupled to the additional portable electronic device 300 through the interface 360, other communication functions may be temporarily disabled. For example, short-range communications and/or the communication subsystem may be turned off to inhibit, for example, internet surfing utilizing the portable electronic device 100 or the portable electronic device 300. Some portable electronic device functions or software may also be disabled. For example, games and/or other software may be disabled when the portable electronic device 100 is coupled to the additional portable electronic device 300 through the interface 360.

The interface 360 may also include a security device, such as a dongle, to verify authorization to utilize the portable electronic device 100. The interface 360 may also include a security device to verify authorization to utilize the portable electronic device 300. One or more security devices 372 may be part of or physically locked to the interface 360.

In the example shown in FIG. 3, the interface 360 includes a binder or folder 302 that receives the portable electronic device 100 and the portable electronic device 300. The folder 302 physically secures the portable electronic devices 100, 300 in an orientation such that a long side of the portable electronic device 100 is adjacent to a long side of the portable electronic device 300 and the touch-sensitive display 118 of the portable electronic device 100 faces the same direction as a touch-sensitive display 318 of portable electronic device 300. The touch-sensitive display 318 may be the same as the touch-sensitive display 118 of portable electronic devices 100, as described above. The portable electronic devices 100, 300 are therefore temporarily attached to the interface 360 and fixed in a known relation to each other. Alternatively, the interface 360 may be a flat device that does not fold. Additional features may be provided to physically secure the portable electronic devices 100, 300 to the interface 360 such that inadvertent movement does not dislodge the portable electronic devices 100, 300. For example, the members 362, 364 may include a lip, a side support, or other features that mate with various physical features of the portable electronic devices 100, 300 to retain them to the interface 360.

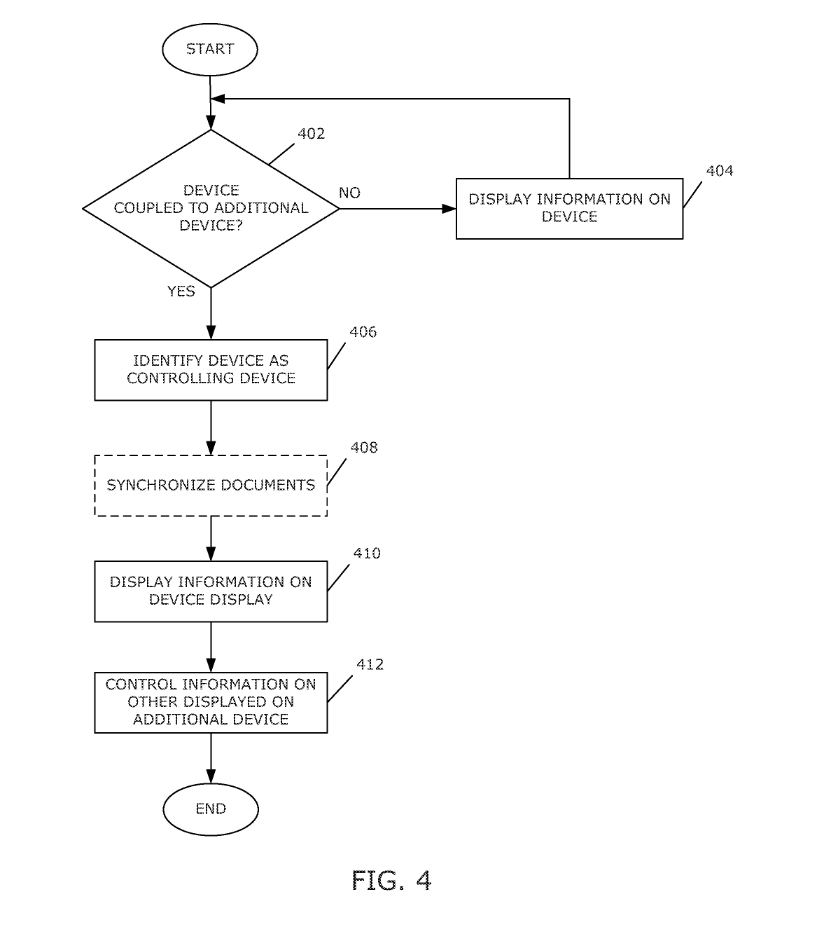

A flowchart illustrating a method of controlling display of information is shown in FIG. 4. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

When the portable electronic device 100 is not coupled to an additional portable electronic device at 402, information is displayed 404 on the touch-sensitive display 118 of the portable electronic device 100. The portable electronic device 100 is not dependent on any other portable electronic device to display the information.

The portable electronic device 100 may be coupled to the additional portable electronic device 300, for example, utilizing the interface 360. Alternatively, the portable electronic device 100 may be directly coupled to the additional portable electronic device 300 by a wireless or a wired communication path. Coupling of the portable electronic devices 100, 300 includes establishing communication between the devices 100, 300 via one or more wireless or wired communication paths.

When the portable electronic device 100 is coupled to the additional portable electronic device 300 at 402, utilizing the interface 300, the interface 360 authenticates the portable electronic devices 100, 300. Alternatively, the portable electronic device 100 may authenticate the additional portable electronic device 300, or vice versa, utilizing unique identification codes on the portable electronic device 100 and the portable electronic device 300.

When the portable electronic device 100 is coupled to an additional portable electronic device 100 at 402, a controlling device is identified 406 among the portable electronic devices 100, 300. When the portable electronic device 100 is identified as the controlling device, the processor 102 of the portable electronic device 100 is utilized to control the additional portable electronic device 300. The controlling device may be selected by the interface 360 or may be selected by the portable electronic devices 100, 300 as described. The controlling device 100 may be identified based on physical position of the portable electronic device 100 relative to the additional portable electronic device 300. For example, the controlling device may always be identified as the device on the left. Alternatively, the controlling device may be identified based on which device is connected to the interface 360 first, based on the persons, e.g., pilot or co-pilot, associated with the portable electronic device 100 and the additional portable electronic device 300, based on a version of a document stored on the portable electronic device 100 and the version of the document stored on the additional portable electronic device 300, or based on any other suitable factor.

A document that is stored on the portable electronic device 100 may optionally be synchronized 408 with a document that is stored on the portable electronic device 300. The documents include the information for display and may be synchronized, for example, when the information displayed is retrieved from both documents such that information displayed on the touch-sensitive display 118 is retrieved from memory 110 of the portable electronic device 100 and information displayed on the touch-sensitive display 318 is retrieved from memory of the portable electronic device 300. Alternatively, information displayed on both touch-sensitive displays 118, 318 may be retrieved from memory 110 of the controlling portable electronic device 100 or the memory of the non-controlling portable electronic device 300.

Information is displayed 410 on the touch-sensitive display 118 and the processor 102 controls 412 the additional portable electronic device 300 to display information on the touch-sensitive display 318. The information displayed on the touch-sensitive display 118 is different from the information displayed on the touch-sensitive display 318. The processor 102 of the portable electronic device 100 sends control instructions to the additional portable electronic device 300 to control the display 318. The processor 102 of the portable electronic device 100 may optionally directly control the display of information of the touch-sensitive display 318 of the additional portable electronic device 300, wherein the processor 102 of the additional portable electronic device 300 either provides direct control of the touch-sensitive display 318 to the processor 102 of the portable electronic device 100 or executes instructions from the processor 102 of the device 100 without further processing, although the processor 102 of the device 300 may retrieve the document information to be displayed.

The information displayed on the touch-sensitive display 118 and on the touch-sensitive display 318 may be successive pages of the document such that the portable electronic device 100 displays one page and the portable electronic device 300 displays a subsequent or next page of the document. The information may include a table of contents such that one of the touch-sensitive displays 118, 318 is utilized to display the table of contents and the other touch-sensitive display 118, 318 is utilized to display a page of the document. A table of contents may be utilized for selection and searching content of the document utilizing one of the displays 118, 318 while displaying selected content on the other of the displays 118, 318. In another example, search results may be displayed on one portable electronic device, while content of the search is displayed on the other portable electronic device, e.g., which one of the search results is highlighted or hovered over on one device, the full text for that search result may be displayed on the other device. Versatile display and search capabilities such as described provide many advantages over paper books beyond storage of a vast quantity of information, such as quickly finding and displaying sought-for information from many documents or locations, highlighting search terms, and displaying numerous search results quickly and simultaneously for easy reference.

The information displayed on the touch-sensitive display 318 may be information that is retrieved from the document stored on the portable electronic device 100 and sent to the portable electronic device 300. Alternatively, the information displayed on the touch-sensitive display 318 may be information that is retrieved from the document stored on the portable electronic device 300 in accordance with control instructions received from the portable electronic device 100.

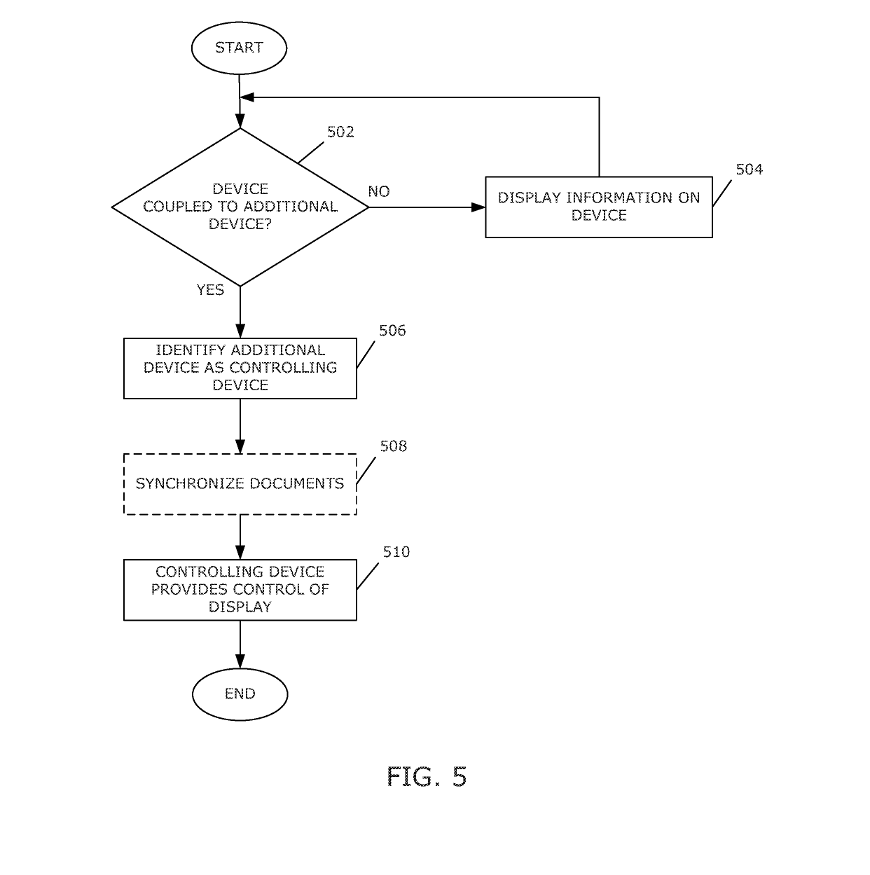

A flowchart illustrating a method of display control is shown in FIG. 5. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

When the portable electronic device 300 is not coupled to another portable electronic device at 502, information is displayed 504 on the touch-sensitive display 118 of the portable electronic device 300. The portable electronic device 300 is not dependent on any other portable electronic device to display the information.

The portable electronic device 100 may be coupled to the additional portable electronic device 300, for example, utilizing the interface 360. Alternatively, the portable electronic device 100 may be directly coupled to the additional portable electronic device 300 by a wireless or a wired communication path. Coupling of the portable electronic devices 100, 300 includes establishing communication between the devices 100, 300 via one or more wireless or wired communication paths.

When the portable electronic device 300 is coupled to an additional portable electronic device 100 at 502, a controlling device is identified 506 among the portable electronic devices 100, 300. When the portable electronic device 100 is identified as the controlling device, the processor of the portable electronic device 300 receives control instructions from the portable electronic device 100.

The document that is stored on the portable electronic device 300 may optionally be synchronized 508 with a document that is stored on the portable electronic device 100. Synchronization of the document may be controlled by the portable electronic device 100.

Control of the touch-sensitive display 318 of the portable electronic device 300 is handed 510 over to or taken by the portable electronic device 100. Control of the display 318 may be taken by the portable electronic device 100 when instructions to display information on the touch-sensitive display 318 are received at the processor of the portable electronic device 300. Alternatively, the portable electronic device 300 may hand over control by sending a message to the portable electronic device 100 over the established communication link. The processor of the portable electronic device 300 receives instructions on the content to display from the processor of portable electronic device 100 that provides control of displayed information. The processor 102 of the portable electronic device 100 may optionally directly control the display of information of the touch-sensitive display 318 of the additional portable electronic device 300, wherein the processor 102 of the additional portable electronic device 300 either provides direct control of the touch-sensitive display 318 to the processor 102 of the portable electronic device 100 or executes instructions from the processor 102 of the device 100 without further processing, although the processor 102 of the device 300 may retrieve the document information to be displayed.

When the portable electronic device 300 is uncoupled, or disconnected, from the first portable electronic device 100, the portable electronic device 300 is no longer controlled by the portable electronic device 100 and may operate independently to display information. The portable electronic device 300 discontinues processes involving the portable electronic device 100.

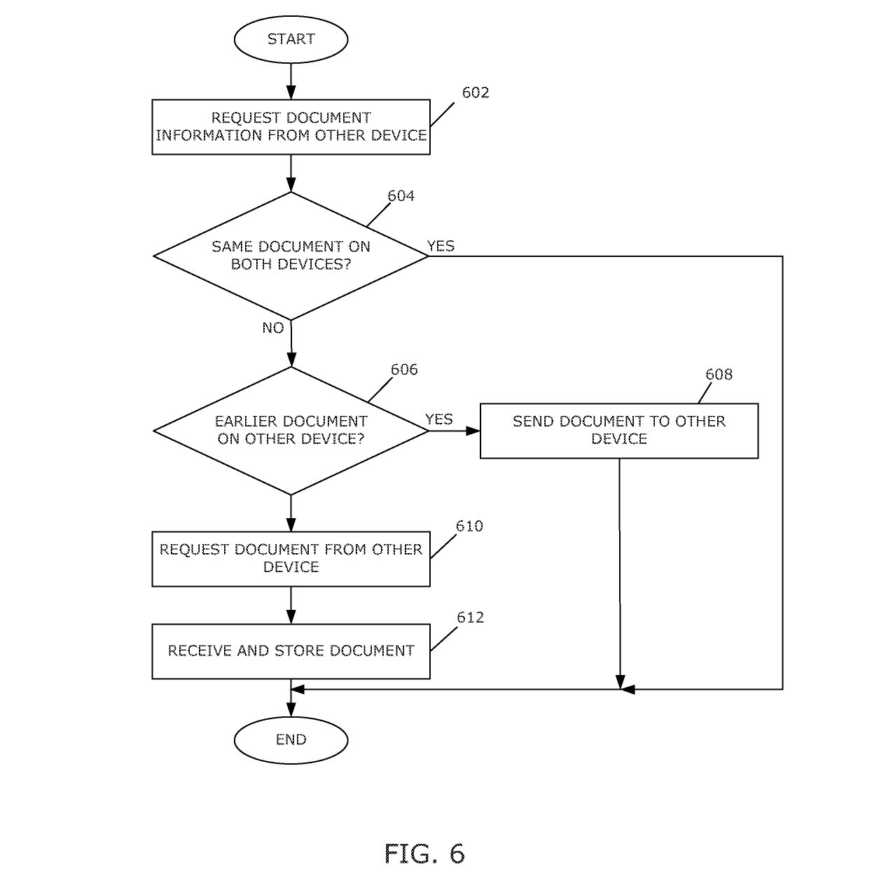

An example of an optional method of synchronization of documents is shown in the flowchart of FIG. 6. The method may be carried out by software executed, for example, by the processor 102 to identify a selected document from which information is displayed. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

To identify the document from which information is displayed, the controlling portable electronic device 100 requests and receives 602 information associated with the document stored on the additional portable electronic device 300. The information may be, for example, a hash value determined by performing a hash function on the document data. The hash function may be performed by the processor of the portable electronic device 300 in accordance with the request received from the controlling portable electronic device 100.

The portable electronic device 100 also compares 604 the information received from the portable electronic device 300 to information associated with the document stored on the portable electronic device 100 to determine whether the document is the same on both the portable electronic device 100 and the portable electronic device 300. For example, the portable electronic device 100 may perform a hash function on the document stored in memory 110 and compare the resulting hash value to the hash value received from the portable electronic device 300. When the hash values are the same, the document is the same on both portable electronic devices 100, 300.

When the document is the same on both portable electronic devices 100, 300, the synchronization process ends. When the document is not the same on both portable electronic devices 100, 300, the process continues at 606 to identify a selected document. When the document on the additional portable electronic device 300 is an earlier or older document at 606, the document stored on the portable electronic device 100 is identified as the selected document and the selected document is sent 608 from the portable electronic device 100 to the portable electronic device 300. The portable electronic device 300 may store the document received from the portable electronic device 100. A document may be determined to be an earlier or older document, for example, based on the version of the document.

When the document on the portable electronic device 300 is a more recent document at 606, the document stored on the portable electronic device 100 is identified as the selected document and the portable electronic device 100 requests 610 the document from the portable electronic device 300, which sends the document to the portable electronic device 100 via the established communication path between the devices 100, 300. The document is received at the portable electronic device 100 and stored 612 in memory 110. The document may be stored in memory as an additional document, rather than writing over the previous document. The previous document may still be utilized, for example, when the document stored in memory is corrupted or unusable.

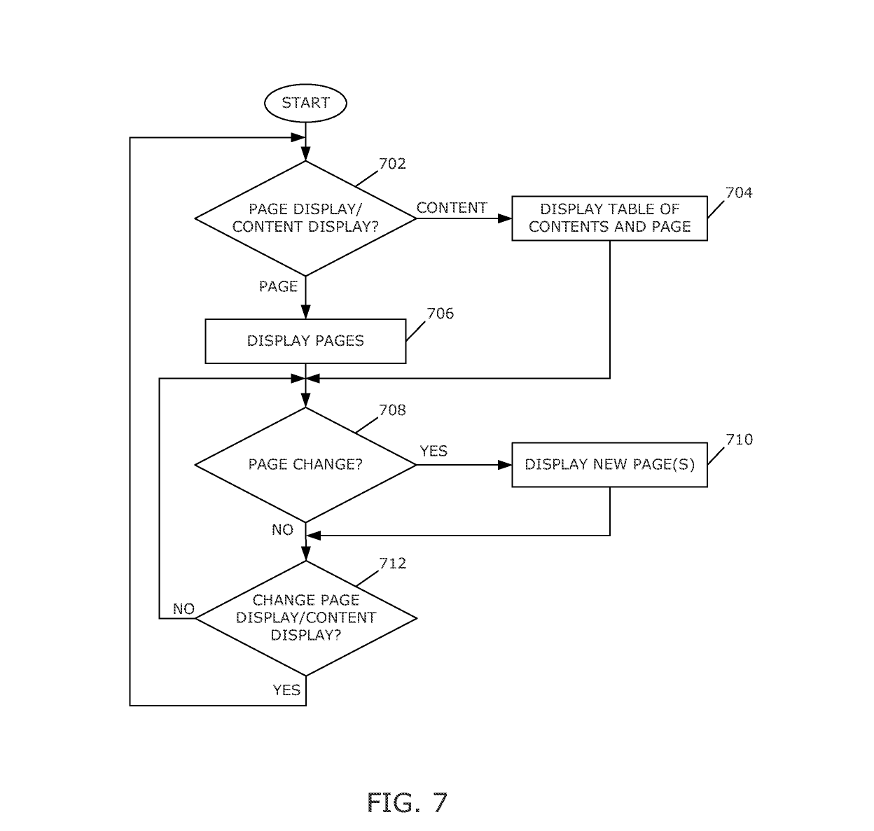

A flowchart illustrating an example of a method of coordinating the display of information is shown in FIG. 7. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

For the purpose of the example illustrated in FIG. 7, the information may include a table of contents. The controlling portable electronic device 100 may include, for example, an option to display a table of contents or to display pages of the document. When the information includes a table of contents at 702, the table of contents is displayed 704 on one of the touch-sensitive displays 118, 318. The touch-sensitive display 118, 318 that is utilized to display the table of contents may be determined in any suitable manner. For example, the touch-sensitive display 118 on the left side may be the default display utilized for displaying the table of contents. The displayed information may optionally be switched, for example, in response to receipt of an input such as a gesture detected on one or both of the touch-sensitive displays 118, 318. Alternatively or optionally, search results may be displayed instead of the table of contents.

An input such as a gesture on the portable electronic device 100, 300 utilized to display the table of contents may change a page displayed on the touch-sensitive display 118, 318 of the other portable electronic device 100, 300. An input such as a gesture on the portable electronic device 100, 300 utilized to display the page, may change the page displayed by that portable electronic device 100, 300.

When the information does not include a table of contents at 702, two pages of the document are displayed 706 such that the touch-sensitive display 118 displays a page of the document and the touch-sensitive display 318 displays the next page of the document.

The pages may be changed by advancing to the next pages or by going back to previous pages in response to receipt of input at one or both of the touch-sensitive displays 118, 318. When an input to change the pages is received at 708, a new page or pages are displayed 710. Input, such as a gesture on one of the portable electronic devices 100, 300, may change the displayed information on both touch-sensitive displays 118, 318. For example, an input such as a gesture from left to right on the touch-sensitive display 318, may be detected by the portable electronic device 300 and included in signals provided or reported to the controlling portable electronic device 100. The signals include input information and are processed at the processor 102. When the processor 102 receives the signals, the signals are associated with a page turning command and the pages are advanced to display the next two pages. Alternatively, the input may be received and processed at the portable electronic device 100. In another example, input such as gestures in the reverse direction may be utilized to decrement pages or go back to earlier pages.

The pages may be advanced by two pages as described. Alternatively, the pages may be advanced such that a page previously displayed on the touch-sensitive display 318 is displayed on the touch-sensitive display 118 and the following page is displayed on the touch-sensitive display 318. Optionally, different input or gestures may be utilized to advance by a different number of pages. For example, a single touch swipe may be utilized such that a page previously displayed on the touch-sensitive display 318 is displayed on the touch-sensitive display 118 and the next page is displayed on the touch-sensitive display 318. A double touch swipe may be utilized to display the next two pages on the touch-sensitive displays 118, 318. Optionally, longer or faster gestures may be utilized to skip pages, e.g., a swipe extending side-to-side may advance or decrement by 5 or 10 pages at a time.

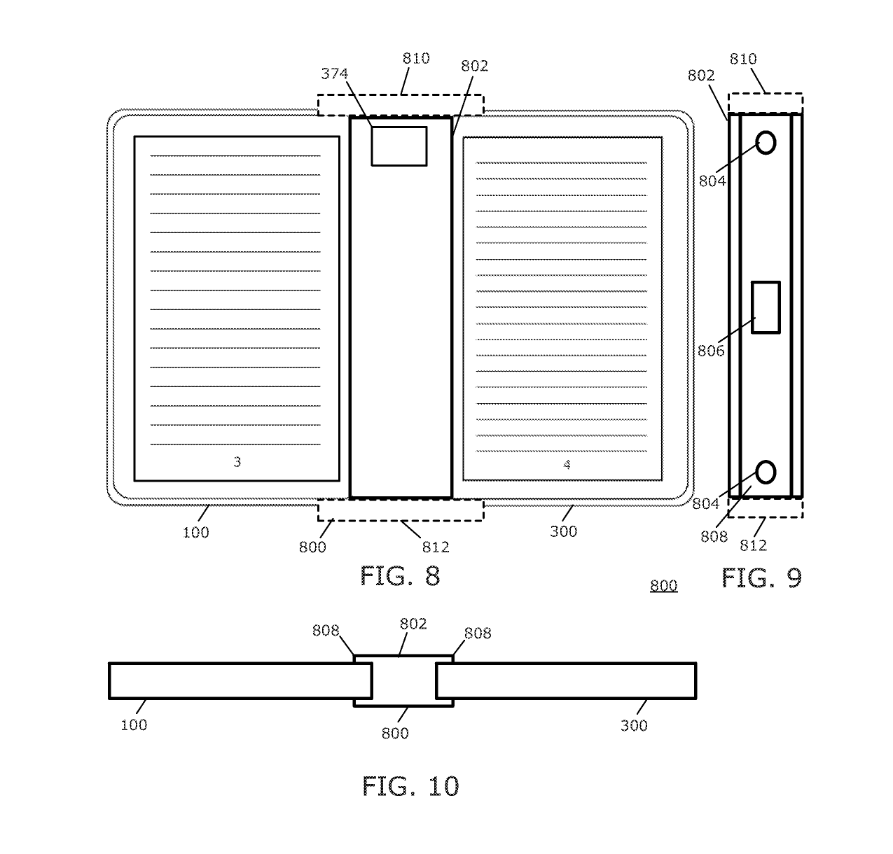

Another example of an interface coupling the portable electronic device 100 and the portable electronic device 300 is illustrated in FIG. 8 through FIG. 10. In the example of FIG. 8 through FIG. 10, the interface 800 includes a rigid housing 802 that extends about the length of a long side of the portable electronic device 100. The rigid housing 802 mechanically couples to the portable electronic device 100 and to the portable electronic device 300 to temporarily secure the two portable electronic devices 100, 300 in a fixed or known physical relation to each other. The mechanical connections 804 may include any suitable mechanical interlock or fastener to cooperate with the portable electronic devices 100, 300 and facilitate a physically secure connection of the housing 802 to the portable electronic devices 100, 300. For example, socket and pin connections or mating posts and holes may be provided. These connections 804 may have an interference fit to provide a stronger connection. In the example illustrated, the rigid housing 802 includes sides 808 that are shaped to provide a groove into which the portable electronic device 100 is received and the portable electronic device 300 is received. The sides 808 provide additional mechanical rigidity when the portable electronic devices 100, 300 are coupled to the interface 800. Although physically different than the interface 360, the interface 800 may electrically and logically operate in the same manner as the interface 360, such as described above.

A data connector 806 extends from each side of the interface 800. The data connector 806 may be, for example, a USB connector or any of the connectors described above. The data connector 806 on one side of the interface 800 is received in a port on a side of the portable electronic device 100 and the data connector on the opposite side of the interface 800 is received in a port on the side of the portable electronic device 800. The portable electronic device 100 is electrically coupled to the portable electronic device 300 through the interface 800. Optionally, the interface 800 may include further supports 810, 812 that mate with various physical features of the portable electronic devices 100, 300 to retain them more securely to the interface 800 to prevent inadvertent uncoupling of the portable electronic devices 100, 300 from the interface 800. For example, the supports 810, 812 may be sized and shaped to create an interference fit with the outer perimeter of the portable electronic devices 100, 300, e.g., along the vertical extent of the portable electronic devices 100, 300.

Optionally, the interface 360, 800 may include a charging element 374 that may be a power connection to a power supply utilizing the interface or may be a connection to a power supply or battery that is part of the interface.

A method includes establishing communication between a first portable electronic device and a second portable electronic device, wherein the first portable electronic device includes a first processor and by the first processor, displaying first information on a first display of the first electronic device and controlling the second portable electronic device to display second information on a second display of the second portable electronic device. Another method includes establishing communication between a first portable electronic device and a second portable electronic device, wherein the first portable electronic device includes a first processor and receiving and following control instructions from a second processor of the second portable electronic device to coordinate display of first information on the first display with display of second information on a second display of the second portable electronic device when the processor of the first portable electronic device is not a controlling processor. An interface includes a first connector for coupling to a first portable electronic device, a second connector for coupling to a second portable electronic device, and a processor. The processor is configured to identify when the first portable electronic device is coupled to the interface, identify when the second portable electronic device is coupled to the interface and provide a control for identifying which of the first portable electronic device and the second portable electronic device controls display of information associated with an application, wherein first information is displayed on the first portable electronic device and a second information is displayed on the second portable electronic device.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

1. A method comprising:
establishing communication between a first portable electronic device and a second portable electronic device, wherein the first portable electronic device includes a first processor;
by the first processor, displaying first information on a first display of the first electronic device and controlling the second portable electronic device to display second information on a second display of the second portable electronic device.

2. The method according to claim 1, wherein controlling comprises providing instructions to a second processor of the second portable electronic device to display the second information.

3. The method according to claim 1, wherein controlling comprises directly controlling the second display to display information.

4. The method according to claim 1, comprising, by the first portable electronic device, authenticating the second portable electronic device.

5. The method according to claim 1, comprising authenticating an interface utilizing the first portable electronic device and the second portable electronic device.

6. The method of claim 1, wherein a document comprises the first information and the second information and wherein the method comprises coordinating display of the document on the first display and controlling the second portable electronic device to display a second page of the document on the second display.

7. The method of claim 1, comprising coordinating display of a document on the first display and controlling the second portable electronic device such that consecutive pages of the document are displayed on the first display and the second display at one time.

8. The method according to claim 1, comprising identifying that the first processor is a controlling processor from among one of the first processor of the first portable electronic device and a second processor of the second portable electronic device.

9. The method according to claim 1, comprising receiving a signal from the second portable electronic device, which signal includes input detected at the second portable electronic device.

10. The method according to claim 9, comprising processing the signal at the first portable electronic device.

11. The method according to claim 9, wherein third information and fourth information is displayed on the first display and the second display in response to the input.

12. The method according to claim 1, wherein establishing is performed when the first portable electronic device is physically coupled to the second portable electronic device.

13. The method of claim 1, comprising coordinating display of a document such that a page of the document and a table of contents are displayed on the first display and the second display.

14. The method of claim 1, comprising identifying as a selected document one of a first document stored on the first portable electronic device and a second document stored on the second portable electronic device, wherein the selected document comprises the first information and the second information.

15. The method of claim 14, wherein identifying comprises comparing a hash of the first document to a hash of the second document to determine whether the first document and the second document are the same.

16. The method of claim 14, comprising receiving, at the first portable electronic device, the second document when the second document is identified as the selected document.

17. The method of claim 14, wherein identifying comprises, when the first document is different than the second document, identifying which of the first document and the second document is a more recent document, and identifying the more recent document as the selected document.

18. The method of claim 17, comprising sending the more recent document to the second portable electronic device when the first portable electronic device has the more recent document.

19. The method according to claim 1, wherein communications are established by wireline connection, and wherein the method comprises disabling wireless communications when communications are established.

20. A method comprising:
establishing communication between a first portable electronic device and a second portable electronic device, wherein the first portable electronic device includes a first processor;
receiving and following control instructions from a second processor of the second portable electronic device to coordinate display of first information on the first display with display of second information on a second display of the second portable electronic device when the processor of the first portable electronic device is not a controlling processor.

21. The method according to claim 20, wherein receiving and following comprises receiving instructions from the second processor to display the first information.

22. The method according to claim 20, wherein direct control of the first display to display the first information is provided to the second portable electronic device.

23. The method according to claim 20, wherein the first portable electronic device is authenticated by the second portable electronic device.

24. The method according to claim 20, wherein a document comprises the first information and the second information and wherein the method comprises receiving control instructions to display a first page of the document on the first display.

25. The method according to claim 20, comprising identifying that the second processor is the controlling processor from among one of the first processor and the second processor.

26. The method according to claim 20, comprising receiving an input at the first portable electronic device and sending a signal including the input to the second portable electronic device to process the input.

27. The method according to claim 26, wherein third information and fourth information is displayed on the first display and the second display in response to the input.

28. The method according to claim 20, comprising reporting received input to the second portable electronic device.

29. The method according to claim 28, wherein the input comprises a gesture detected utilizing a touch-sensitive overlay on the second display of the second portable electronic device.

30. The method according to claim 23, wherein when receiving and following control instructions, handing control of the first display to the second electronic device and not interfering with the control.

31. An interface comprising:
a first connector for coupling to a first portable electronic device;
a second connector for coupling to a second portable electronic device;
a processor configured to:
identify when the first portable electronic device is coupled to the interface;
identify when the second portable electronic device is coupled to the interface;
provide a control for identifying which of the first portable electronic device and the second portable electronic device controls display of information associated with an application, wherein first information is displayed on the first portable electronic device and a second information is displayed on the second portable electronic device.

32. The interface of claim 31, further comprising a security device to authenticate the first portable electronic device and the second portable electronic device.

33. The interface of claim 31, further comprising a dongle to provide security between the first portable electronic device and the second portable electronic device.

34. The interface of claim 31, further comprising at least one charging element for charging at least one of the first portable electronic device and the second portable electronic device.

35. The interface of claim 31, wherein the first portable electronic device and second portable electronic device are mechanically coupled utilizing the interface such that the first portable electronic device and second portable electronic device are physically arranged in relation to each other.

36. The interface of claim 31, wherein the first portable electronic device is mechanically coupled to the interface in a first orientation and the second portable electronic device is mechanically coupled to the interface in a second orientation such that the first display and the second display are fixed in a known relation.

37. The interface of claim 31, wherein the processor is configured to identify when the first portable electronic device is uncoupled from the interface and notify the second portable electronic device.

38. The interface of claim 37, comprising the second portable electronic device discontinuing processes involving the first portable electronic device.

39. The interface of claim 37, wherein the first portable electronic device and second portable electronic device are secured to the interface to prevent inadvertent uncoupling of the first portable electronic device or the second portable electronic device from the interface.

40. A method comprising:
establishing communication between a first portable electronic device and a second portable electronic device, wherein the first portable electronic device includes a first processor;
by the first processor, displaying first information on a first display of the first electronic device and controlling the second portable electronic device to display second information on a second display of the second portable electronic device, wherein a document comprises the first information and the second information;
coordinating display of the document on the first display and controlling the second portable electronic device to display a second page of the document on the second display.

41. The method of claim 40, comprising coordinating display of the document such that changing display of the first information results in changing display of the second information.

42. The method of claim 1, comprising coordinating display of a document on the first display and controlling the second portable electronic device such that consecutive pages of the document are displayed on the first display and the second display at one time.

43. The method of claim 1, comprising coordinating display of a document such that a page of the document and a table of contents are displayed on the first display and the second display.

44. The method of claim 1, comprising controlling display of the document by the first processor at a first time and by a second processor of the second portable electronic device at a second time that is different than the first time.
